(19) United States
(12) Patent Application Publication
(10) Pub. No.: US 2006/0121896 A1
(43) Pub. Date: Jun. 8, 2006

(54) Method for user identification in a CTCSS based radio communication system

(76) Inventor: Lee Wai Tin, Hong Kong (HK)

Correspondence Address: Dennis W. Beech;LAW OFFICES OF DENNIS W. BEECH, Suite C-2, 19900 Beach Blvd., Huntington Beach, CA, 92648, US

(21) Appl. No.: 11/007,691

(22) Filed: Dec. 8, 2004

(51) Int. Cl. H04Q 7/20

(52) U.S. Cl. 455/434

(57) ABSTRACT

The invention may be used for communication between a plurality of users in a frequency modulated radio communication system having a continuous tone controlled squelch system, CTCSS. An audio frequency channel and multiple CTCSS sub-channels may be selected for a carrier signal transmission between multiple users. A distinct one of the CTCSS sub-channels may be assigned to each user. The carrier signal may be transmitted with the audio frequency channel and one of the CTCSS sub-channels. The audio frequency channel may be monitored to detect the carrier signal. The detected signal may be monitored to detect a CTCSS sub-channel signal. If a selected CTCSS sub-channel signal may be detected, an audio output device may be activated.

### BACKGROUND OF THE INVENTION

This invention relates to continuous tone controlled squelch systems, CTCSS, and frequency modulated radio communication. The new method and system may allow communication between multiple users in a group of users of family radio systems wherein CTCSS sub-channels of a selected audio frequency channel may be assigned to specific users to create a distinct CTCSS sub-channel for each user to respond to a selected transmitted carrier signal.

In some frequency modulation radio communication systems, a tone of radio frequency that may be below that which may be reproduced by a radio receiver in the voice band is transmitted to activate a selected receiver or receivers. This may be done to provide privacy and prevent undesired messages from being produced by other receivers during the transmission or may be used to squelch unwanted transmission reception by a receiver. For example, in a two-way radio system a continuous sub-audio, i.e., below approximately 300 Hz, single frequency tone may be selected for transmission between the two parties that may be transmitted with the voice signal. The method that may be commonly referred to as CTCSS generates the continuous tone signal combined with the audio or voice signal to be transmitted from a sender to an intended receiver. The receiver may then process the voice signal once it has detected the correct tone signal. Signals received by the receiver that do not have the proper continuous tone signal will not be processed. In a continuous tone controlled squelch system the tones may normally be arranged in a frequency band well below 300 Hz to reduce interference with any voice or audio signal transmitted.

### SUMMARY OF THE INVENTION

The present invention is directed to a method for communication between a plurality of users in a frequency modulated radio communication system having a continuous tone controlled squelch system, CTCSS. An audio frequency channel and multiple CTCSS sub-channels may be selected for a carrier signal transmission between multiple users. A distinct one of the CTCSS sub-channels may be assigned to each user. The carrier signal may be transmitted with the audio frequency channel and one of the CTCSS sub-channels. The audio frequency channel may be monitored to detect the carrier signal. The detected signal may be monitored to detect a CTCSS sub-channel signal. If a selected CTCSS sub-channel signal may be detected, an audio output device may be activated.

These and other features, aspects and advantages of the present invention will become better understood with reference to the following drawings, description and claims.

### BRIEF DESCRIPTION OF THE DRAWINGS

FIG. 1 illustrates a flowchart of a generally basic CTCSS method that may currently be in use;

FIG. 2 illustrates a flowchart of a user identification method that may currently be in use;

FIG. 3 illustrates a selected channel and sub-channel display according to an embodiment of the invention.

### DETAILED DESCRIPTION

The following detailed description represents the best currently contemplated modes for carrying out the invention. The description is not to be taken in a limiting sense, but is made merely for the purpose of illustrating the general principles of the invention.

A frequency modulated radio communication system for communication between multiple users may have a continuous tone controlled squelch system or CTCSS as understood in the industry. The CTCSS system may facilitate two-way radio communication between users and suppress or squelch receipt of signals from unwanted transmitting radios or other sources. The CTCSS system may include frequency tone signals or channels in a frequency band lower than audio frequency bands such that the CTCSS sub-channels may be at frequencies less than 300 Hz.

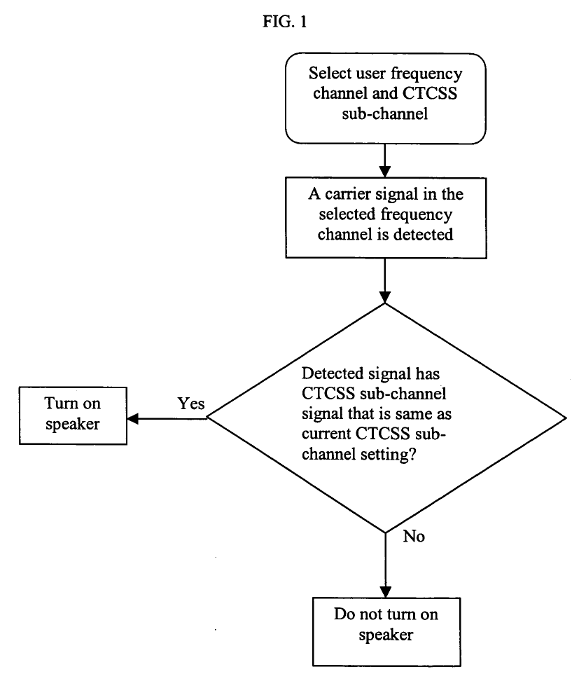

Referring to FIG. 1, a method for communication between multiple users of a CTCSS based radio communication system is illustrated. In general for operation of radio devices that may be termed a family radio system that includes a CTCSS element, a user audio frequency channel and a CTCSS sub-channel may be selected for enabling communication between radio devices. The radio devices may monitor the selected audio frequency channel to detect a carrier signal transmission from a transmitting radio device. If a carrier signal is detected, the receiving radio device may monitor to detect the selected CTCSS sub-channel and in the event of detection may activate or turn on an audio output device, such as, a speaker or like device. If the selected CTCSS sub-channel is not detected the audio device may not be activated.

A CTCSS based radio communication system may also have a public designated sub-channel, for example, sub-channel number 00, that may always activate an audio output device when the carrier frequency with the selected audio frequency channel may be detected.

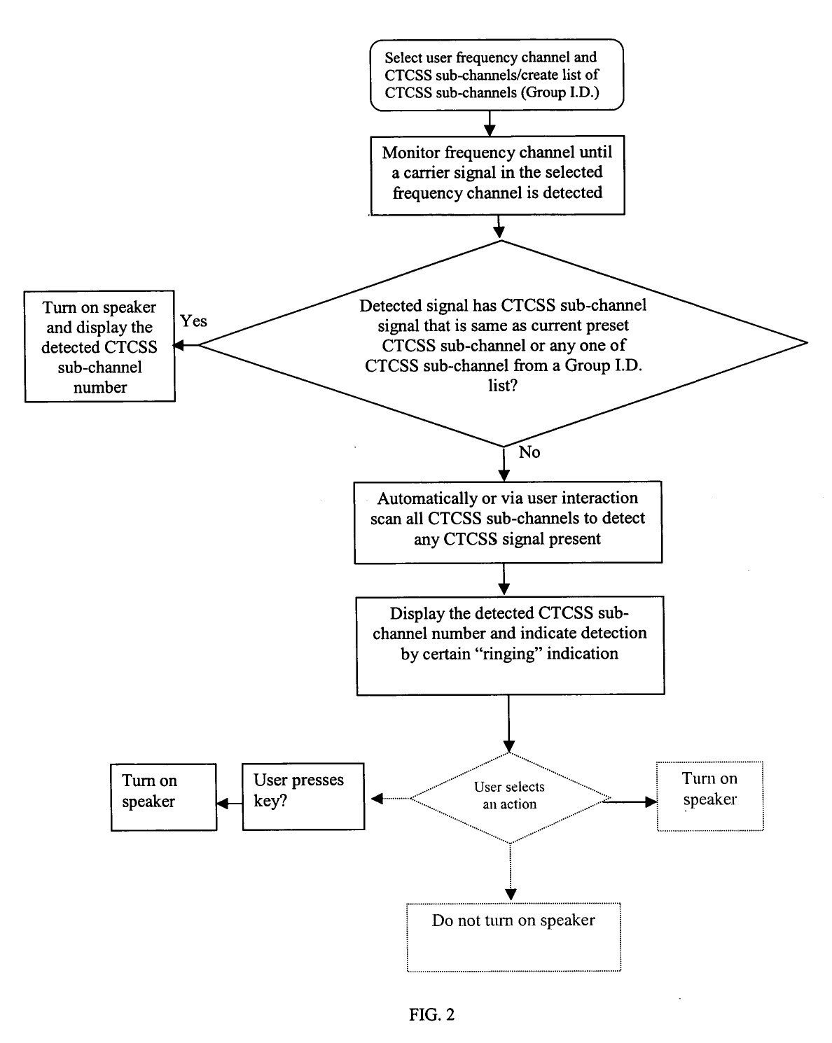

Referring to FIG. 2, the more general operation of a CTCSS based radio communication system may be modified for cooperative use between multiple users in a group to allow caller or transmitter identification within the group to only activate a selected or distinct receiver user or group of users. Multiple CTCSS sub-channels within a selected audio frequency channel may be assigned to each user of the group of users such that each user has its own distinct CTCSS sub-channel assigned. The selected CTCSS sub-channels may be a Group. ID list in the selected audio frequency channel that may be used for operational modes for the group of users. When a carrier signal with audio frequency channel and one of the CTCSS sub-channels may be transmitted, the radio devices may monitor the audio frequency channel to detect the carrier signal. When the carrier signal may be detected, the radio devices may monitor to detect either a preset CTCSS sub-channel or any one of the CTCSS sub-channels of the Group ID list. If any one of the selected CTCSS sub-channel is detected by a particular user radio device, an audio output device may be activated. If none of the selected CTCSS sub-channels is detected the audio output device may not be activated. In this manner the users in a group may selectively listen and communicate or suppress and squelch unwanted signals.

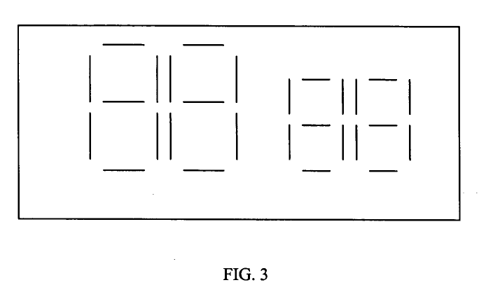

The user identification CTCSS based radio communication system may also have a display as illustrated in FIG. 3 that may display the audio frequency channel and the CTCSS sub-channel that is being transmitted or received. A user may use the display to determine whether or not to enable the audio output device with an input device, such as, a switch, key or the like. For user operation, there may be options: 1) to activate an audio output device when any CTCSS sub-channel is detected; 2) to not activate an audio output device when any CTCSS sub-channel other than selected ones are detected; or 3) to activate an audio output device when the user activates a switch or key. There may also be a received signal indicator, such as, a ringing tone, flashing display or the like, to alert a user to the receipt of any selected CTCSS sub-channel.

While the invention has been particularly shown and described with respect to the illustrated embodiments thereof, it will be understood by those skilled in the art that the foregoing and other changes in form and details may be made therein without departing from the spirit and scope of the invention.

I claim:

1. A method for communication between a plurality of users in a frequency modulated radio communication system having a continuous tone controlled squelch system, CTCSS, comprising:
a) selecting an audio frequency channel and a plurality of CTCSS sub-channels for a carrier signal transmission between the plurality of users;
b) assigning a distinct one of said plurality of CTCSS sub-channels to each of said users;
c) transmitting said carrier signal with said audio frequency channel and one of said plurality of CTCSS sub-channels;
d) monitoring said audio frequency channel to detect said carrier signal;
c) monitoring said carrier signal to detect any one of said plurality of CTCSS sub-channels as one of a preset CTCSS sub-channel and any CTCSS sub-channel in a Group ID list; and
f) activating an audio output device upon detection of said any one of said plurality of CTCSS sub-channels.

2. The method as in claim 1 further comprising displaying said audio frequency channel and said CTCSS sub-channel upon detection of said any one of said plurality of CTCSS sub-channels.

3. The method as in claim 1 further comprising activating a received signal indicator upon detection of said any one of said plurality of CTCSS sub-channels.

4. The method as in claim 1 further comprising selecting an option mode from one of:
a) activating said audio output device when any CTCSS sub-channel is detected;
b) activating said audio output device only when said any one of said plurality of CTCSS sub-channels and said any CTCSS sub-channel in a Group ID list is detected; and
c) activating said audio output device when said user activates an input device.

5. A communication system produced for communication between a plurality of users according to the method of claim 1.

6. A communication system produced for communication between a plurality of users according to the method of claim 2.

7. A communication system produced for communication between a plurality of users according to the method of claim 3.

8. A communication system produced for communication between a plurality of users according to the method of claim 4.
